(19) United States
(12) Patent Application Publication
(10) Pub. No.: US 2015/0054357 A1
(43) Pub. Date: Feb. 26, 2015

(54) ARMATURE OF CORELESS LINEAR MOTOR AND CORELESS LINEAR MOTOR USING THE SAME

(71) Applicant: Korea University Research and Business Foundation, Seoul (KR)

(72) Inventors: Hoon Heo, Seoul (KR); Hong-Youn Kim, Seoul (KR)

(73) Assignee: KOREA UNIVERSITY RESEARCH AND BUSINESS FOUNDATION, Seoul (KR)

(21) Appl. No.: 14/378,748

(22) PCT Filed: Dec. 26, 2013
(86) PCT No.: PCT/KR2013/012193

§ 371 Date: Aug. 14, 2014

(30) Foreign Application Priority Data
Jan. 9, 2013 (KR) 10-2013-0002317

(51) Int. Cl. H02K 41/03

(52) U.S. Cl. CPC H02K 41/031
USPC 310/12.18

(57) ABSTRACT

The invention relates to a coreless linear motor and a method for manufacturing the same. The armature according to the invention comprises: an armature winding having at least one unit coil row which is formed by overlapping a plurality of coil rows; and a molded portion which surrounds the armature winding; wherein each coil row has a first coil portion and a second coil portion which have opposite winding directions; and wherein the plurality of coil rows which forms one unit coil row are overlapped such that the first coil portions are arranged in order and the second coil portions are arranged in order. Accordingly, the coil rows overlapped inside allow higher output with the same size.

### TECHNICAL FIELD

The invention relates to an armature of coreless linear motor and coreless linear motor using the same and in particular to an armature of coreless linear motor and coreless linear motor using the same having a compact size, high power and high acceleration in which a unit coil row is formed by overlapping a plurality of coil rows.

### BACKGROUND ART

As is well known, a linear motor generates linear driving force and therefore need no transforming mechanism. Also, contactless straight movement of the linear motor allows high-speed and stable operation and therefore such precise operation facilitates the used of the linear motor in the industrial field.

Generally, the linear motor comprise a stator having permanent magnets whose poles are arranged alternately and a mover (an armature) having a core to which coils are wound and a straight driving force is generated by the interaction between the magnetic force of permanent magnets and the magnetic force of the mover coil when current is applied to the coils of the mover.

Also, a coreless linear motor is known which maintains the winding-wire state of the mover coils and facilitates structural rigidity by the injection-molding of the molded body to surround wound mover coils and the circumference of the mover coils without using a mover core.

US patent publication U.S. Pat. No. 4,318,038 discloses a moving-coil linear motor which generates high acceleration, static force and speed with no ripple effect and which does not need a plurality of magnets of high price or a coil assembly that tends to be overheated.

Korean patent laid-open publication No. 2010-84120 discloses a coreless linear motor in the form of flux-through-type mover coils wherein a field pole of a stator is arranged on both sides of the armature which constitutes a mover.

FIG. 1 represents a general coreless linear motor such as a coreless linear motor shown in the above Korean laid-open patent publication and FIG. 2 is a cross-section view taken from the line II-II of FIG. 1. Referring to FIGS. 1 and 2, a general coreless linear motor is a linear motor in the form of flux-through-type moving coils wherein field a pole 8 of a stator is arranged on both sides of the armature 1 which constitutes a mover.

The filed pole 8 comprises a field pole yoke 9 having the section of [symbol] shape and permanent magnets 10a and 10b which are arranged inside of the yoke and which are arranged perpendicularly to the paper in such a manner that poles of the magnet are opposite to each other.

As shown in FIG. 3, the armature 1 comprises an armature winding 5 and a T-shaped molded body 7. The armature winding 5 has a plurality of coil rows 5a on the wiring substrate in such a manner that the coil rows are spaced apart from magnet rows of the permanent magnets 10a and 10b and the coil rows are arranged opposite to each other. The molded body 7 is injection-molded to surround the armature winding 5 by filling molding resins into the gap between coil rows 5a and onto the surface and then by adhering the resins.

Refrigerant path 13 is formed by the space surrounded by a molded body 7, cans 2a and 2b and a frame 3. A reference numeral 4 indicates a base.

As shown in FIG. 3, coil rows 5a of the armature winding 5 are spaced apart with a predetermined interval. In FIG. 3, reference numeral 12 denotes a power cable to supply current to the armature winding 5.

When current is applied to the armature winding 5 of the general coreless linear motor, the armature 1 moves straight in the direction of the arrangement of the armature winding 5 by the electromagnetic interaction between the magnetic force generated from the armature winding 5 and the flus of the permanent magnets 10a and 10b.

Recently, for the linear motor which is used for the transfer in a transfer device, an axis of machine tool, a semiconductor production apparatus, an optical inspection apparatus, an apparatus for inspecting liquid crystal, etc., in particular for the structure of the armature, higher driving force, accuracy and acceleration is required and more compact size is also required.

However, since the armature of the prior coreless linear motor is configured such that coil rows 5a are arranged in a row as shown in FIG. 3, there is a limit to reduce the size. Also, with the armature structure having the same size, there is a limit to increase driving force and acceleration.

### DISCLOSURE OF THE INVENTION

### Technical Problem

The object of the invention is to solve the above problems and in particular, to provide a method for determining abnormal gait more accurately even with fewer sensors.

### Technical Solution

The above object is accomplished by an armature of a coreless linear motor comprising: an armature winding having at least one unit coil row which is formed by overlapping a plurality of coil rows; and a molded portion which surrounds the armature winding; wherein each coil row has a first coil portion and a second coil portion which have opposite winding directions; and wherein the plurality of coil rows which forms one unit coil row are overlapped such that the first coil portions are arranged in order and the second coil portions are arranged in order.

Here, the plurality of coil rows which forms one unit coil row comprise a first coil row, a second coil row and a third coil row which are overlapped with each other; the second coil row is overlapped with the first coil row such that the first coil portion and the second coil portion of the second coil row are arranged on one side of the first coil portion and the second coil portion of the first coil row; and the third coil row is overlapped with the first coil row such that the first coil portion and the second coil portion of the third coil row are arranged on the other side of the first coil portion and the second coil portion of the first coil row.

Also, the first coil row is wound to have the shape of a race track; and both side of the first coil portion and the second coil portion are bended to form a bended portion such that each of the second coil row and the third coil row is overlapped with the first coil row.

Also, the bended portions of the second and third coil rows are bended in opposite directions such that the second coil rows and third coil rows are overlapped with the first coil row in opposite directions.

Further, wherein the second coil row and the third coil row are overlapped with the first coil row such that the profile of the first coil portions and the second coil portions in the direction of the arrangement of the first coil portions and the second coil portions is in the shape of I.

Moreover, the above object is also attained by a coreless linear motor comprising: a stator having a plurality of permanent magnets which are arranged in such a manner that north and south poles are disposed alternately and which are arranged in such a manner that the poles of the magnets in one side are the same as those of the corresponding magnets disposed in the opposite side; and an armature which is arranged between the permanent magnets; wherein the armature comprises: an armature winding having at least one unit coil row which is formed by overlapping a plurality of coil rows; and a molded portion which surrounds the armature winding; wherein each coil row has a first coil portion and a second coil portion which have opposite winding directions; and wherein the plurality of coil rows which forms one unit coil row are overlapped such that the first coil portions are arranged in order and the second coil portions are arranged in order.

### Advantageous Effect

According to the invention as described above, the armature of the coreless linear motor and the coreless linear motor using the same having coil rows overlapped inside are provided which generate higher output with the same size.

Further, since the molded portion is manufactured by epoxy molding only, by epoxy molding after the injection molding or by the use of die casting for the case and the epoxy molding for the inside, the fixing of the armature winding can be carried out simultaneously with the molding process thereby reducing the number of processes and the manufacturing cost and increasing work efficiency.

### BRIEF DESCRIPTION OF THE DRAWINGS

FIG. 1 represents a general coreless linear motor such as a coreless linear motor shown in the Korean laid-open patent publication No. 2010-84120.

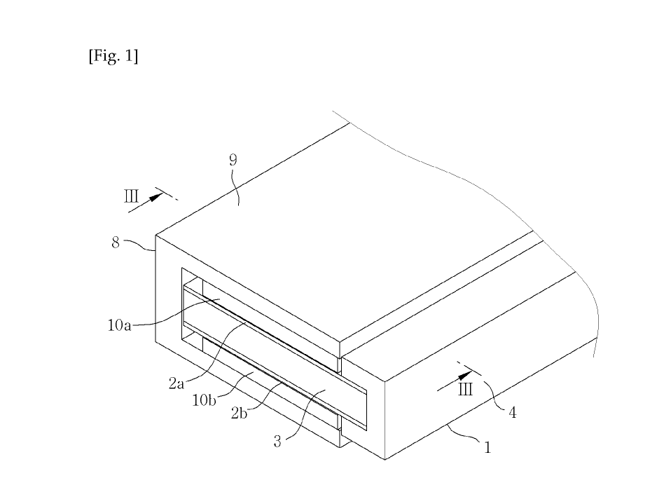

FIG. 2 is a cross-section view taken from the line II-II of FIG. 1.

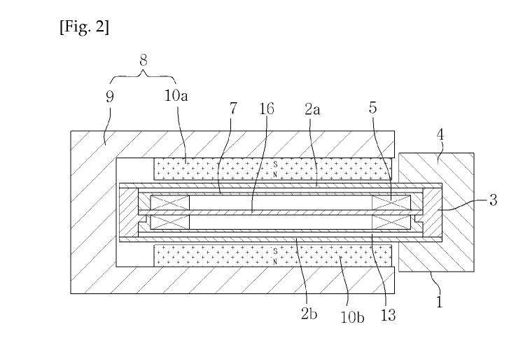

FIG. 3 is a cross-section view of an armature of a coreless linear motor of prior art.

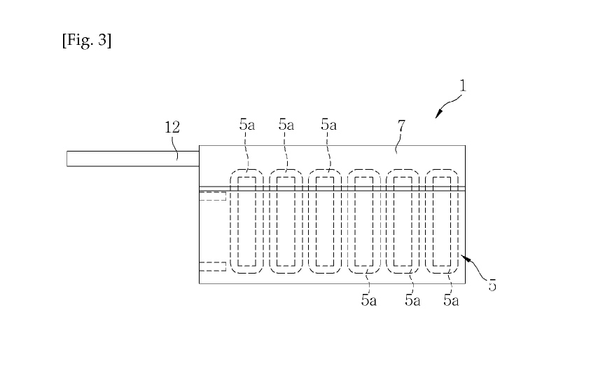

FIG. 4 is a perspective view of an armature according to the present invention.

FIG. 5 is a cross-section view taken from the line V-V of FIG. 4.

FIG. 6 is a perspective view of a unit coil row of an armature according to the present invention.

FIG. 7 is a side view seen from the direction of A of FIG. 6.

FIG. 8 represents the comparison of armature windings of the present invention and armature windings of the prior art.

FIG. 9 represents a coreless linear motor according to the present invention.

### BEST MODE FOR CARRYING OUT THE INVENTION

An armature of a coreless linear motor according to the invention comprises: an armature winding having at least one unit coil row which is formed by overlapping a plurality of coil rows; and a molded portion which surrounds the armature winding; wherein each coil row has a first coil portion and a second coil portion which have opposite winding directions; and wherein the plurality of coil rows which forms one unit coil row are overlapped such that the first coil portions are arranged in order and the second coil portions are arranged in order.

### Mode for Carrying Out the Invention

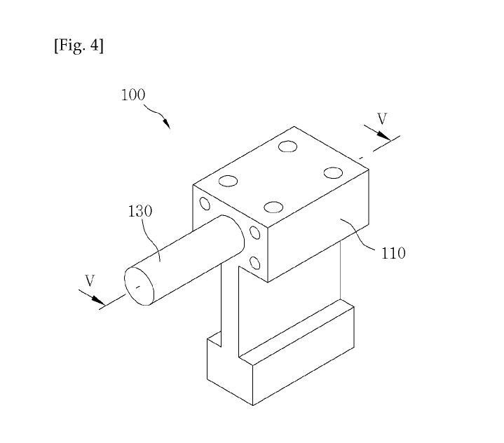

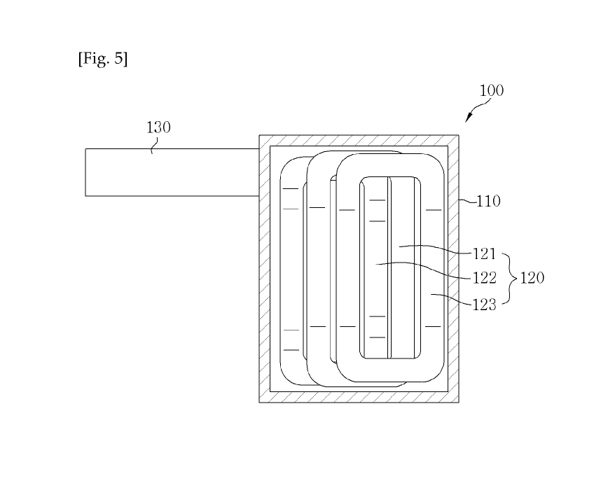

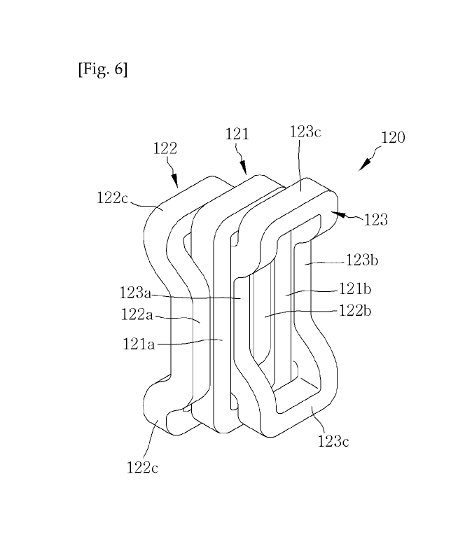

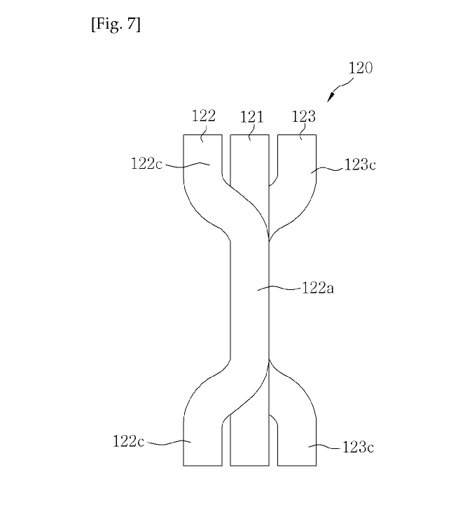

Hereinafter, preferred embodiments according to the present invention will be explained in detail referring to attached drawings. FIG. 4 is a perspective view of an armature 100 according to the present invention, FIG. 5 is a cross-section view taken from the line V-V of FIG. 4, FIG. 6 is a perspective view of a unit coil row 120 of an armature 100 according to the present invention, and FIG. 7 is a side view seen from the direction of A of FIG. 6.

The armature 100 of a coreless linear motor according to the present invention comprises an armature winding 120a and a molded portion 110. Here, the armature winding 120a comprises at least a unit coil row 120 and the molded portion 110 winds the armature winding 120a.

The molded portion 110 is formed by epoxy molding only or by epoxy molding after the injection molding. Also, molded portion 110 can be formed by the use of die casting for the case and by the epoxy molding for the inside. For the fixation of the armature winding 120a, the manufacturing is carried out simultaneously with the molding process, thereby reducing the number of processes.

The unit coil row 120 which forms the armature winding 120a is formed by overlapping a plurality of coil rows 121, 122 and 123. In one example, as shown in FIGS. 4 to 7, three coil rows 121, 122 and 123 are overlapping to form one unit coil row 120.

Herein, each coil row 121, 122 and 123 comprises a first coil portion 121a, 122a and 123a and a second coil portion 121b, 122b and 123b. The first coil portion 121a, 122a and 123a and the second coil portion 121b, 122b and 123b have the opposite winding direction. A plurality of coil rows 121, 122 and 123 are overlapped with each other to form one unit coil row 120 in such a manner that the first coil portions 121a, 122a and 123a are arranged in order and then the second coil portions 121b, 122b and 123b are arranged in order.

Hereinafter, a plurality of coil rows 121, 122 and 123 which forms one unit coil row 120 are defined as a first coil row 121, a second coil row 122 and a third coil row 123, respectively.

Referring to FIG. 6, the second coil row 122 is overlapped with the first coil row 121 such that the first coil portion 122a and the second coil portion 122b of the second coil row 122 are arranged on one side (the left in FIG. 6) of the first coil portion 121a and the second coil portion 121b of the first coil row 121.

Further, the third coil row 123 is overlapped with the first coil row 121 such that the first coil portion 123a and the second coil portion 123b of the third coil row 123 are arranged on the other side (the right in FIG. 6) of the first coil portion 121a and the second coil portion 121b of the first coil row 121.

Thus, the first coil portion 122a of the second coil row 122, the first coil portion 121a of the first coil row 121 and the first coil portion 123a of the third coil row 123 are arranged in order and the second coil portion 122b of the second coil row 122, the second coil portion 121b of the first coil row 121 and the second coil portion 123b of the third coil row 123 are arranged in order.

Herein, the first coil row 121 has the shape of a race track such that the second coil row 122 and the third coil row 123 is overlapped with the first coil row 121. Also, both sides of the first coil portion 122a and 123a and the second coil portion 122b and 123b are bended to form bended portion 122c and 123c such that each of the second coil row 122 and the third coil row 123 is overlapped with the first coil row 121.

As shown in FIG. 7, the bended portions 122c and 123c of the second and third coil rows 122 and 123 are bended in opposite directions such that the second and third coil rows 122 and 123 are overlapped with the firs coil row 121 in opposite direction. Therefore, the second coil row 122 and the third coil row 123 are overlapped with the first coil row 121 such that the profile of the first coil portion 121a, 122a and 123a and the second coil portion 121b, 122b and 123b is in the shape of I, as shown in FIG. 7.

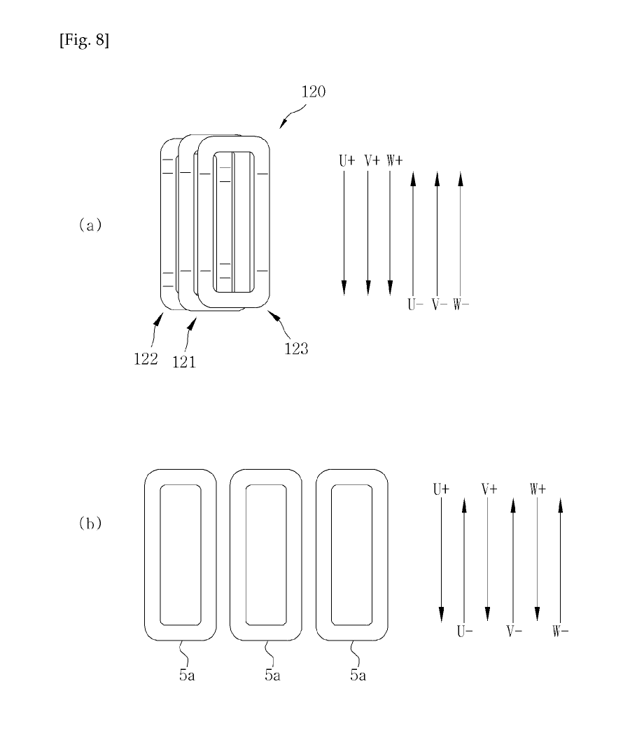

FIG. 8 represents the comparison of an armature winding 120a of the present invention and an armature winding 120a of the prior art. FIG. 8 (a) shows the arrangement of the armature winding 120a of the present invention and FIG. 8 (b) shows the arrangement of the armature winding 120a of the prior art.

As shown in FIG. 8, the armature winding 120a of the present invention has a plurality of coil rows which are overlapped and therefore the size of the armature winding 120a of the present invention is remarkably reduced compared to the armature winding of the prior art.

Further, in case that the armature winding 120a according to the present invention is configured to have three phases U, V and W, the phases are arranged horizontally in order of the following: U+, V+, W+, U−, V− and W−. In case of the armature winding 120a according to prior art, the phases are horizontally arranged in order of the following: U+, U−, V+, V−, W+and W−.

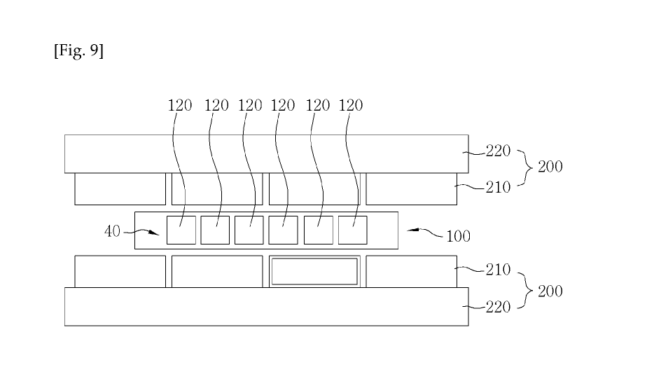

FIG. 9 represents a coreless linear motor according to the present invention. The linear motor according to the present invention comprises a stator 200 and the armature 100 as described above.

The stator 200 comprises a plurality of permanent magnets 210 which are arranged in such a manner that north and south poles are disposed alternately and which are arranged in such a manner that the poles of the magnets in one side are the same as those of the corresponding magnets disposed in the opposite side. The magnets 210 are fixed to the fixing plate 220 such that they are arranged to face each other.

The armature 100 is arranged between the permanent magnets 210 of the stator 200 and the armature 100 moves straight in the direction of the arrangement of the armature winding 120a by the electromagnetic interaction between the magnetic force of the armature winding 120a and the magnetic flux of the magnets 210 when current is applied to the armature winding 120a of the armature 100. That is, a straight driving force is generated.

Hereinafter, a method for manufacturing the armature 100 of the linear motor according to the present invention as described above will be explained.

First, the first coil row 121, the second coil row 122 and the third coil row 123 are wound by a jig (not shown in the drawings). The number and arrangement of windings may vary depending on the requirements and the design specifications.

Then, the second coil row 122 and the third coil row 123 of the wound first, second and third coil rows 121, 122 and 123 are bended at both sides to form bended portions 122c and 123c. Then, after the bended portions 122c and 123c of the second and the third coil rows 122 and 123 are formed, the second coil row 122 and the third coil row 123 are overlapped with the first coil row 121 as explained above, thereby making a unit coil row 120.

According to the required specifications, injection-molding or epoxy-molding is carried out for one or more of the unit coil rows 120 manufactured by the above to surround the unit coil row by the molded portion with I-shaped molding jig (not shown).

Although several exemplary embodiments of the present invention have been illustrated and described, it will be appreciated that various modifications can be made without departing from the scope and spirit of the invention as disclosed in the accompanying claims. The scope of the present invention will be determined the accompanying claims and their equivalents.

<Reference Numerals>

| 100: armature | 120a: armature winding |
|---|---|
| 120: unit coil row | 121: the first coil row |
| 122: the second coil row | 123: the third coil row |
| 121a, 122a, 123a: the first coil portion | |
| 121b, 122b, 123b: the second coil portion | |
| 122c, 123c: bended portion | |
| 200: stator | 210: permanent magnet |
| 220: fixing plate | |

### INDUSTRIAL APPLICABILITY

The armature of the coreless linear motor and the coreless linear motor using the same can be applied to various industrial field since they generates linear driving force and allow fast and slow operations as well as an accurate operation.

1. An armature of a coreless linear motor comprising:
an armature winding having at least one unit coil row which is formed by overlapping a plurality of coil rows; and
a molded portion which surrounds the armature winding;
wherein each coil row has a first coil portion and a second coil portion which have opposite winding directions; and
wherein the plurality of coil rows which forms one unit coil row are overlapped such that the first coil portions are arranged in order and the second coil portions are arranged in order.

2. The armature of the coreless linear motor according to claim 1,
wherein the plurality of coil rows which forms one unit coil row comprise a first coil row, a second coil row and a third coil row which are overlapped with each other;
wherein the second coil row is overlapped with the first coil row such that the first coil portion and the second coil portion of the second coil row are arranged on one side of the first coil portion and the second coil portion of the first coil row; and
wherein the third coil row is overlapped with the first coil row such that the first coil portion and the second coil portion of the third coil row are arranged on the other side of the first coil portion and the second coil portion of the first coil row.

3. The armature of the coreless linear motor according to claim 2,
wherein the first coil row is wound to have the shape of a race track; and
wherein both side of the first coil portion and the second coil portion are bended to form a bended portion such that each of the second coil row and the third coil row is overlapped with the first coil row.

4. The armature of the coreless linear motor according to claim 3, wherein the bended portions of the second and third coil rows are bended in opposite directions such that the second coil rows and third coil rows are overlapped with the first coil row in opposite directions.

5. The armature of the coreless linear motor according to claim 3, wherein the second coil row and the third coil row are overlapped with the first coil row such that the profile of the first coil portions and the second coil portions in the direction of the arrangement of the first coil portions and the second coil portions is in the shape of I.

6. A coreless linear motor comprising:
a stator having a plurality of permanent magnets which are arranged in such a manner that north and south poles are disposed alternately and which are arranged in such a manner that the poles of the magnets in one side are the same as those of the corresponding magnets disposed in the opposite side; and
an armature which is arranged between the permanent magnets;
wherein the armature comprises:
an armature winding having at least one unit coil row which is formed by overlapping a plurality of coil rows; and
a molded portion which surrounds the armature winding;
wherein each coil row has a first coil portion and a second coil portion which have opposite winding directions; and
wherein the plurality of coil rows which forms one unit coil row are overlapped such that the first coil portions are arranged in order and the second coil portions are arranged in order.

7. The coreless linear motor according to claim 6,
wherein the plurality of coil rows which forms one unit coil row comprise a first coil row, a second coil row and a third coil row which are overlapped with each other;
wherein the second coil row is overlapped with the first coil row such that the first coil portion and the second coil portion of the second coil row are arranged on one side of the first coil portion and the second coil portion of the first coil row; and
wherein the third coil row is overlapped with the first coil row such that the first coil portion and the second coil portion of the third coil row are arranged on the other side of the first coil portion and the second coil portion of the first coil row.

8. The coreless linear motor according to claim 7,
wherein the first coil row is wound to have the shape of a race track; and
wherein both side of the first coil portion and the second coil portion are bended to form a bended portion such that each of the second coil row and the third coil row is overlapped with the first coil row.

9. The coreless linear motor according to claim 8, wherein the bended portions of the second and third coil rows are bended in opposite directions such that the second coil rows and third coil rows are overlapped with the first coil row in opposite directions.

10. The coreless linear motor according to claim 8, wherein the second coil row and the third coil row are overlapped with the first coil row such that the profile of the first coil portions and the second coil portions in the direction of the arrangement of the first coil portions and the second coil portions is in the shape of I.
